(19) United States
(12) Patent Application Publication
(10) Pub. No.: US 2011/0235588 A1
(43) Pub. Date: Sep. 29, 2011

(54) METHOD, DEVICE, AND MULTI-ADDRESS SPACE MOBILE NETWORK FOR SENDING DATA AND FORWARDING DATA

(75) Inventor: Xiaohu Xu, Beijing (CN)

(73) Assignee: Huawei Technologies Co., Ltd., Shenzhen (CN)

(21) Appl. No.: 13/153,134

(22) Filed: Jun. 3, 2011

Related U.S. Application Data
(63) Continuation of application No. PCT/CN2009/073723, filed on Sep. 3, 2009.

(30) Foreign Application Priority Data
Dec. 8, 2008 (CN) 200810185721.9

(51) Int. Cl. H04L 12/56; H04W 40/02

(52) U.S. Cl. 370/328; 370/392

(57) ABSTRACT

A method for forwarding data is provided. A first host belongs to a first locator domain (LD). The first LD belongs to a first Internet service provider (ISP) and a second ISP. A second host belongs to a second LD. The ISP to which each LD belongs allocates an LD identifier (LD ID) to the LD, respectively. The method includes: receiving a first data packet sent to the second host by the first host; selecting one LD ID of the first LD as a source LD ID according to a preset traffic engineering (TE) policy, so as to obtain a second data packet corresponding to the first data packet, and selecting an ISP network corresponding to the source LD ID to forward the second data packet.

### CROSS-REFERENCE TO RELATED APPLICATIONS

This application is a continuation of International Application No. PCT/CN2009/073723, filed on Sep. 3, 2009, which claims priority to Chinese Patent Application No. 200810185721.9, filed on Dec. 8, 2008, both of which are hereby incorporated by reference in their entireties.

### FIELD

The present disclosure relates to the field of communication technologies, and in particular, to a method for sending data and forwarding data, a device, and a multi-address space mobile network.

### BACKGROUND

A Node identifier (ID) network architecture is a network protocol system oriented to the next generation Internet. A concept of locator domain (LD) is introduced in the Node ID, and the LD is substantially a network adopting a certain address space, such as the Internet Protocol version 4 (IPv4) and the IPv6. The different LDs can adopt different address spaces.

The existing Node ID network architecture adopts a tree networking structure, where a static core network (CN) and a plurality of moveable edge networks (ENs) exist, and the EN can be directly connected to the CN or indirectly connected to the CN through another EN. The CN and these ENs are different LDs. A router connecting different ENs is referred to as an edge router (ER), and a router connecting the CN and the EN is referred to as a core ER (CER). The CN and each EN in the Node ID network architecture adopt an independent address space, and the CN and the ENs adopting an independent address space are generally referred to as the LD, which is identified with an LD ID.

FIG. 1 is a schematic view of a system with a Node ID network architecture in the prior art, where the system includes one CN and three ENs. The LD of the CN is LD1, and the LDs of the three ENs are respectively LD2, LD3, and LD4, where LD2 and LD3 are connected to the CN through NR2 and NR3, and LD4 is connected to LD2 through NR4. Therefore, NR2 and NR3 belong to CER, and NR4 belongs to the ER.

The sets linked to the CER are generally referred to as edge trees, and the CER is configured to issue a default route to the edge tree. A host added to the EN first sends a registration message along the default route reaching the CER, where the registration message contains a host ID (HI) and a Locator of the host, and the Locator is the location information of the host in the current LD. The CER stores a mapping relation between the HI and the Locator, so that the CER can know how to reach the host in the edge tree linked to the CER when sending the data packet. The CN includes a distributed hash table (DHT) system, configured to store a mapping relation between a CER ID and a CER Locator of the CER in the CN.

In the Node ID network architecture, the data forwarding process specifically includes the following steps.

A source host searches for an HI and a CER ID corresponding to a destination host through a domain name server (DNS), and the DNS stores host names and a mapping relation between the HI and the CER ID. In the following. In order to differentiate two CERs corresponding to the source host and the destination host, the CER corresponding to the source host is referred to as an ingress CER, and the CER corresponding to the destination host is referred to as egress CER. The source host sends a data packet to the ingress CER along the default route reaching the CN, and the packet carries the HI of the destination host and a CER ID of the egress CER. After receiving the data packet from the source host, the ingress CER searches for a Locator corresponding to the CER ID of the egress CER through a DHT in the CN, and sends the received message to the egress CER through the found Locator, and then the egress CER forwards the packet to the destination host.

In view of the above description, in the Node ID architecture in the prior art, the host location information of all hosts in the LD is registered in the DHT of the CN. Therefore, in the existing Node ID architecture, the EN and the CN can only adopt a tree structure for networking, the networking is restricted in terms of the structure, and the communication between different ENs of two LDs has to be performed through the CN, even if the ENs of the two different LDs are close to each other physically and cause poor forwarding route, so the network-level traffic engineering (TE) capability is not realized.

### SUMMARY

Embodiments of the present disclosure provide a method for sending data and forwarding data, a device, and a multi-address space mobile network, so that the network can have a network-level TE capability.

In order to solve the above problems, the present disclosure is illustrated through the following embodiments.

An embodiment of the present disclosure provides a method for forwarding data, where a first host belongs to a first LD, the first LD belongs to a first Internet service provider (ISP) and a second ISP, a second host belongs to a second LD, and the ISP to which each LD belongs allocates an LD ID to the LD respectively, where the method includes: receiving a first data packet sent by the first host to the second host; and selecting one LD ID of the first LD as a source LD ID according to a preset TE policy, so as to obtain a second data packet corresponding to the first data packet, and selecting an ISP network corresponding to the source LD ID to forward the second data packet.

An embodiment of the present disclosure further provides a method for sending data, where the method includes: obtaining LD IDs of a first LD, where the first LD belongs to a first ISP and a second ISP, and selecting one LD ID as a source LD ID; encapsulating the source LD ID in a data packet sent to a second host, where the second host belongs to a second LD; and sending the data packet to an LD border router (LDBR) of the first LD, where the LDBR is connected to an ISP network to which the LDBR belongs.

An embodiment of the present disclosure further provides the following devices.

A router is provided, where the router includes: a receiving unit, configured to receive a first data packet sent by a first host to a second host, where the first host belongs to a first LD, the first LD belongs to a first ISP and a second ISP, the ISPs to which the first LD belongs allocate LD IDs to the first LD, and the second host belongs to a second LD; a selection unit, configured to select one LD ID of the first LD as a source LD ID according to a preset TE policy, so as to obtain a second data packet corresponding to the first data packet; and a sending unit, configured to send the second data packet obtained by the selection unit to an ISP network corresponding to the source LD ID selected by the selection unit.

A host device is provided, where the host device includes: an LD ID obtaining unit, configured to obtain LD IDs of a first LD belonging to ISPs, where the first LD belongs to a first ISP and a second ISP, and the ISPs to which the first LD belongs allocate the LD IDs to the first LD; an LD ID selection unit, configured to select one from the obtained LD IDs; an encapsulation unit, configured to take the LD ID selected by the LD ID selection unit as a source LD ID and encapsulate the source LD ID in a data packet sent to a second host, where the second host belongs to a second LD; and a sending unit, configured to send the data packet encapsulated by the encapsulation unit to a first LDBR, where the first LDBR is connected to an ISP network to which the first LD belongs.

An embodiment of the present disclosure further provides a multi-address space mobile network, where the multi-address space mobile network includes: a plurality of LDs adopting independent address spaces, where each LD has a unique LD ID in the network; a first LD belongs to a first ISP and a second ISP, and different LDs are connected to each other through LDBRs; a first host belongs to the first LD, a second host belongs to a second LD, and the ISPs to which the first LD and the second LD belong allocate the LD IDs to the first LD and the second LD respectively; the first host, configured to send a first data packet to the second host; and a first LDBR, configured to receive a data packet sent by the first host, select one LD ID of the first LD as a source LD ID according to a preset TE policy, so as to obtain a second data packet corresponding to the first data packet, and select an ISP network corresponding to the source LD ID to forward the second data packet.

In view of the above embodiments, when a host belonging to different LDs sends a first data packet, if the first LD to which the first host sending the first data packet belongs to a plurality of ISPs, an LDBR can select one LD ID of the first LD as a source LD ID according to a TE policy, so as to obtain a second data packet corresponding to the first data packet, and select an ISP network corresponding to the source LD ID to forward the second data packet, so as to control traffic forwarding paths into or out from the first LD according to the TE policy, so that the multi-address space mobile network can have a network-level TE capability.

Similarly, when the host belonging to different LDs sends a data packet, if the first host sending the data packet belongs to a plurality of ISPs, one LD ID of the first LD is selected as the ID of a source LD sending the data packet, and the data packet is sent to a border router of the first LD, so as to have a suggestion right for paths through which the traffic passes, so that the multi-address space mobile network can have a network-level TE capability.

### BRIEF DESCRIPTION OF THE DRAWINGS

FIG. 1 is a schematic view of an architecture of a Node ID network in the prior art;

FIG. 2 is a schematic view of an architecture of a network according to an embodiment of the present disclosure;

FIG. 3 is a flow chart of a method for forwarding data according to an embodiment of the present disclosure;

FIG. 4 is a schematic structural view of a router according to an embodiment of the present disclosure; and

FIG. 5 is a schematic structural view of a host device according to an embodiment of the present disclosure.

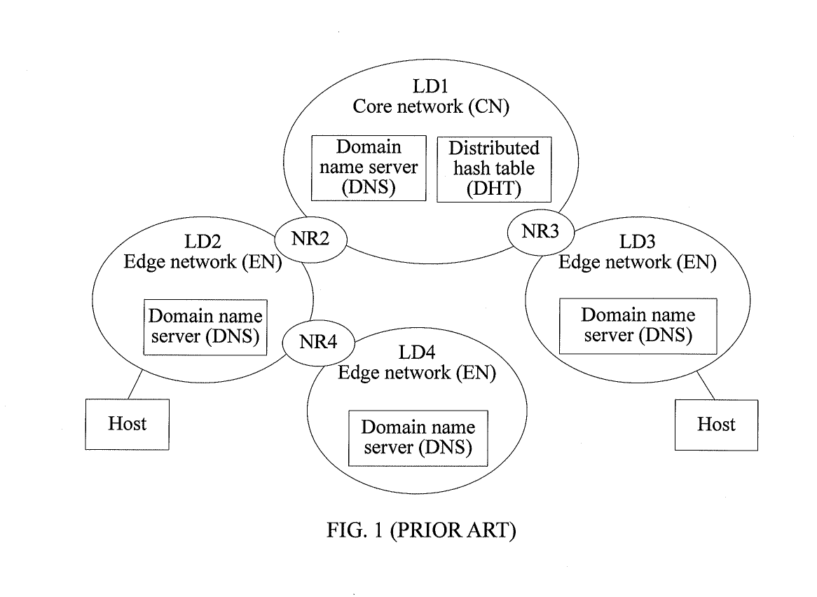

### DETAILED DESCRIPTION OF THE EMBODIMENTS

Embodiments of the present disclosure provide a method for sending data and forwarding data, a device, and a multi-address space mobile network, so that the network can have a network-level TE capability.

In order to make the objectives, solutions, and advantages of the present disclosure more comprehensible, the embodiments of the present disclosure are introduced in detail hereinafter with reference to the accompanying drawings.

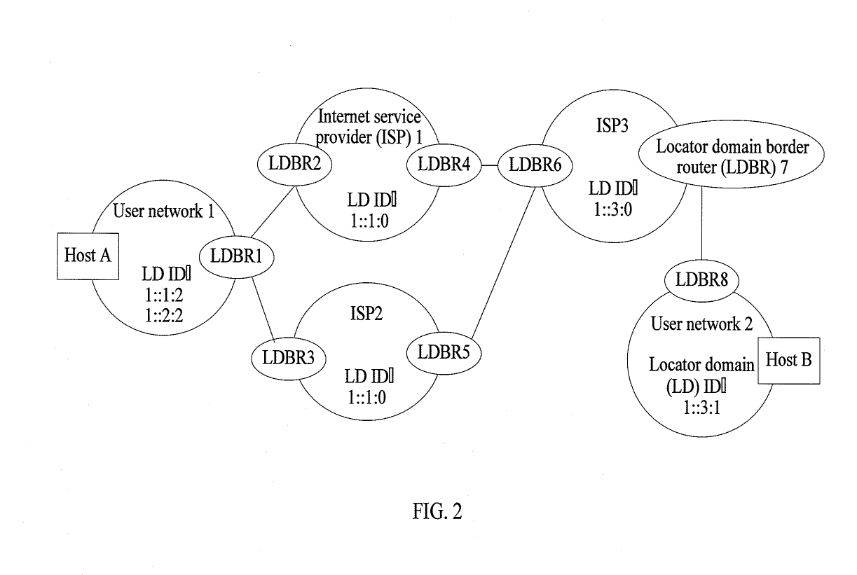

FIG. 2 is a schematic view of an architecture of a network according to an embodiment of the present disclosure. The whole network is formed by a plurality of sub-networks with independent address spaces, and the sub-networks include a user network and an ISP network. The sub-networks with independent address spaces are referred to as LDs, the LDs are connected to each other through LDBRs, and the LDBRs can notify LD reachability information by operating the route protocols such as the border gateway protocol (BGP). Each LD belongs to a particular ISP and can obtain different LD IDs from ISPs to which the LD belongs, and an independent address space is adopted inside each LD, that is, inside different LDs, overlapped or even totally the same address spaces can be adopted.

In specific implementation, the address space adopted inside the LD may be an IPv4 address space, and the LD ID allocated to each LD by the ISP may specifically be a 96-bit unique global addressing, where the addressing can be considered as a /96 prefix of an IPv6 address, and the 96-bit LD ID+32-bit IPv4 address form a special IPv6 address.

The user network may belong to a plurality of ISPs, and therefore can be referred to as a multi-homing user network. The multi-homing user network may obtain an LD ID from each ISP to which the multi-homing user network belongs. Since the LD ID allocated to the user network by each ISP is an LD ID under the jurisdiction of the ISP, so in the ISP network the LD ID can be aggregated according to the topology like the IP address allocated by the existing operators, so as to ensure extensibility of an LD routing table.

In FIG. 2, the whole network is divided into a plurality of LDs according to different ISPs to which the LDs belong, and the LDs are connected to each other through LDBRs respectively. Host A belongs to user network 1, and host B belongs to user network 2. User network 1 belongs to ISP1 and ISP2 respectively, and is connected to the ISP1 network and the ISP2 network through LDBR1. User network 2 belongs to ISP3, and is connected to the ISP3 network through e LDBR8. If the IPv6 address expression method is adopted, the allocated LD ID of the ISP1 network is 1::1:0, the LD ID of the ISP2 network is 1::2:0, the LD ID of the ISP3 network is 1::3:0, the LD ID allocated to the user network 1 by ISP1 is 1::1:2, the LD ID allocated to the user network 1 by ISP2 is 1::2:2, and the LD ID allocated to user network 2 by ISP3 is 1::3:1.

When data packets are transmitted among different LDs in the foregoing network, a destination address of the route is an LD ID, the next hop of the route is an LDBR ID of an LDBR, and the data packet is forwarded through a next hop LDBR reaching a destination LD and is forwarded hop by hop until the data packet is forwarded to the destination LD. A data packet inside an LD is forwarded directly hop by hop with the internal Locator (IPv4 address). In this way, before the data packet is forwarded to the destination LD, the route based on the destination LD ID is adopted, and after the data packet reaches the destination LD, the route based on the IPv4 address of the destination host is adopted to forward the data packet.

For example, host A in user network 1 may send the data packet to host B of user network 2 through the ISP1 network, the source LD ID carried in the data packet is 1::1:2 and the destination LD ID carried in the data packet is 1::3:1, the specific path is: host A→LDBR1→LDBR2→LDBR4→LDBR6→LDBR7→LDBR8, and after the data packet reaches LDBR8, the data packet is forwarded hop by hop through the Locator in user network 2, and is finally sent by LDBR8 to host B. Host A may also send the data packet to user network 2 through the ISP2 network, the source LD ID carried in the data packet is 1::2:2 and the destination LD ID carried in the data packet is 1::3:1, the specific path is: host A→LDBR1→LDBR3→LDBR5→LDBR6→LDBR7→LDBR8, and after reaching LDBR8, the data packet is forwarded hop by hop through the Locator inside user network 2, and is finally sent by LDBR8 to host B.

How data is forwarded in the above network is described below.

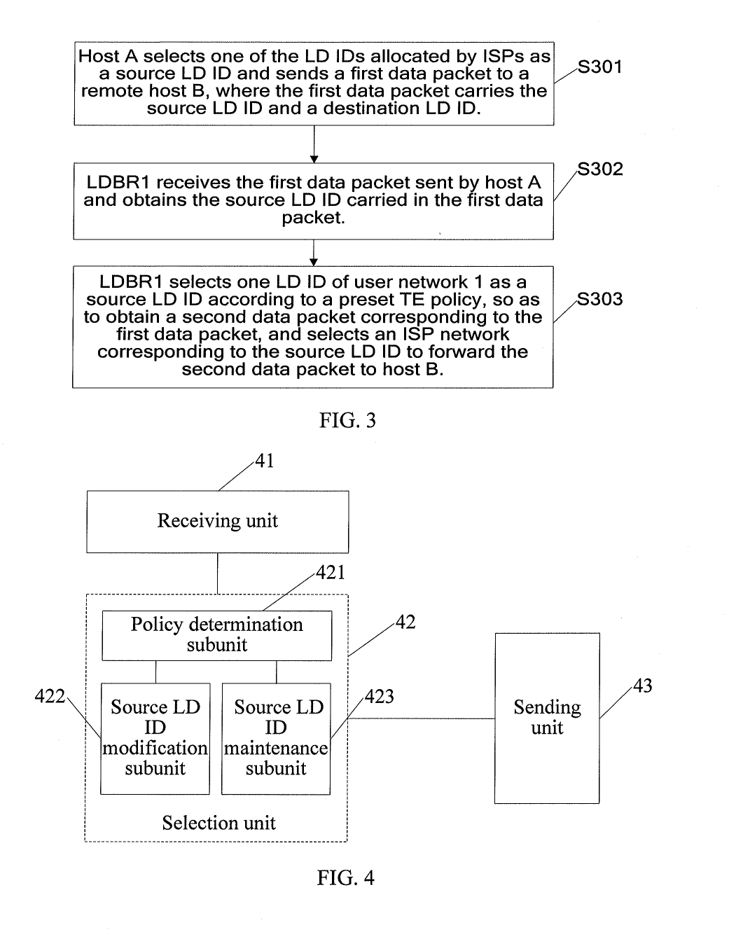

FIG. 3 is a flow chart of a method for forwarding data according to an embodiment of the present disclosure. When LDBR1 receives a first data packet sent by host A to host B, one LD ID of the first LD is selected as a source LD ID according to a preset TE policy, so as to obtain a second data packet corresponding to the first data packet, and an ISP network corresponding to the source LD ID is selected to forward the second data packet, which is described below with reference to FIGS. 2 and 3.

In step S301, host A selects one of the LD IDs allocated by the ISPs as a source LD ID and sends a first data packet to a remote host B, where the first data packet carries the source LD ID and a destination LD ID.

Host A is located in user network 1, user network 1 belongs to ISP1 and ISP2 respectively, the LD ID allocated to user network 1 by ISP1 is 1::1:2, and the LD ID allocated to user network 1 by ISP2 is 1::2:2. Host B is located in user network 2, user network 2 belongs to ISP3, and the LD ID allocated to user network 2 by ISP3 is 1::3:1.

Before sending a data packet to host B, host A first selects one LD ID of user network 1 as a source LD ID. For convenience of description, it is assumed that host A selects the LD ID allocated to user network 1 by ISP1, that is, 1::1:2, and the source LD ID carried in the sent data packet is 1::1:2 and the destination LD ID carried in the sent data packet is 1::3:1.

In step S302, LDBR1 receives the first data packet sent by host A and obtains the source LD ID carried in the first data packet; and

the source LD ID that LDBR1 obtains from the received data packet is 1::1:2, that is, the LD ID selected by the ISP1 for host A.

In step S303, LDBR1 selects one LD ID of user network 1 as a source LD ID according to a preset TE policy, so as to obtain a second data packet corresponding to the first data packet, and selects an ISP network corresponding to the source LD ID to forward the second data packet to the host B.

Here, for convenience of description, the data packet sent by host A received by LDBR1 is referred to as the first data packet, one LD ID of the first LD is selected as the source LD ID according to the preset TE policy, and the data packet carrying the selected source LD ID is referred to as the second data packet. The first data packet and the second data packet are merely used to differentiate the data packets received and sent by LDBR1, and the first data packet and the second data packet may be same or different in practical applications. For example, if LDBR1 directly forwards the data packet to the ISP network corresponding to the source LD ID selected by host A carried in the data packet, or LDBR1 determines that the source LD ID selected by host A conforms to the preset TE policy, the first data packet and the second data packet are same; if LDBR1 determines that the source LD ID selected by host A does not conform to the preset TE policy, the first data packet and the second data packet are different. The detailed description is given below through specific embodiments.

After the data packet reaches LDBR1, LDBR1 selects an ISP network through which the data packet passes according to the source LD ID of the data packet, for example, if host A selects the LD ID allocated by e ISP1 as the source LD ID, LDBR1 forwards the data packet to the ISP1 network, and the path through which the data packet passes before reaching the destination host B is: LDBR1→LDBR2→LDBR4→LDBR6→LDBR7→LDBR8. After reaching LDBR8, the data packet can be sent to host B through the Locator in user network 2.

In this embodiment, a source host selects the source LD ID for sending the data packet, and LDBR1 directly selects an ISP network allocating the source LD ID for forwarding. Therefore, the source host can control the data packet to pass through which upstream ISP network for forwarding, so as to manage the network traffic.

The TE policy implemented by the LDBR1 may be that routes of some hosts in the local LD pass through the ISP1 network, and routes of the other hosts pass through the ISP2 network. The TE may also be implemented according to one or more of the following indexes such as the transmission timeliness, service price, importance of information, transmission reliability, and data sensitivity, so that different data packets can be forwarded through different ISP networks.

For example, if the source LD ID (which is set as the LD ID allocated to user network 1 by ISP1) carried in the data packet conforms to the preset TE policy, the source LD can be maintained unchanged and the data packet is forwarded to an ISP network corresponding to the source LD ID.

If the source LD ID (which is set as the LD ID allocated to user network 1 by e ISP1) carried in the data packet does not conform to the preset TE policy, the source LD may be modified into the LD ID allocated to the user network 1 by ISP2, the ISP2 network corresponding to the modified source LD ID is selected, and the ISP2 network sends the data packet carrying the modified source LD ID sent from host A to host B, so as to select the ISP network again through which the data packet passes.

For example, the source LD ID selected by source host A is the LD ID allocated by ISP1, that is, 1::1:2, when the data packet is received, the LDBR1 modifies the source LD ID of the data packet into the LD ID allocated to the user network 1 by ISP2, that is, 1::2:2, and selects ISP2 network to forward the data packet according to the modified LD ID, and the path through which the data packet passes is: host A→LDBR1→LDBR3→LDBR5→LDBR6→LDBR7→LDBR8. For example, when LDBR1 detects interruption of the ISP1 network, LDBR1 can modify the source LD ID into the LD ID allocated to user network 1 by e ISP2. After reaching LDBR8, the data packet can be sent to the host B through the Locator in user network 2.

It can be seen that, the source host has a suggestion right for the ISP network through which the data packet passes, and LDBR1 of user network 1 has the final determination right, so as to control the network through which the data packet passes, adjust the network traffic, and implement the network-level TE capability.

It should be understood that, the user network, as an independent LD, may belong to three or more ISPs, and when a data packet is sent, the source host can select one of the LD IDs allocated to the user network by the ISPs as a source LD ID; and the LDBR may directly forward the data packet through an ISP network corresponding to the source LD ID carried in the data packet according to a preset TE policy, or may modify the source LD ID into the LD IDs allocated by other ISPs according to the preset TE policy, and select networks of the other ISPs to forward the data packet.

The method for forwarding data according to the embodiment of the present disclosure is described above in detail, and the devices involved in the method are described in the following correspondingly.

FIG. 4 is a schematic structural view of a router according to an embodiment of the present disclosure, where the router includes:

a receiving unit 41, configured to receive a first data packet sent by a first host to a second host, where the first host belongs to a first LD, the first LD belongs to a first ISP and a second ISP, the ISPs to which the first LD belongs allocate LD IDs to the first LD, and the second host belongs to a second LD;

a selection unit 42, configured to select one LD ID of the first LD as a source LD ID according to a preset TE policy, so as to obtain a second data packet corresponding to the first data packet; and

a sending unit 43, configured to send the second data packet obtained by the selection unit 42 to an ISP network corresponding to the source LD ID selected by the selection unit 42.

Specifically, when the LD ID selected by the first host is the LD ID allocated by the first ISP to the LD at which the first host is located, the selection unit 42 specifically includes a policy determination subunit 421 and a source LD ID modification subunit 422, where:

the policy determination subunit 421 is configured to determine whether the LD ID allocated to the first LD by the first ISP conforms to the preset TE policy, and trigger the source LD ID modification subunit 422 when the LD ID does not conform to the preset TE policy; and

the source LD ID modification subunit 422 is configured to modify the source LD ID into an LD ID allocated to the first LD by the second ISP.

The selection unit further includes a source LD ID maintenance subunit 423, and the policy determination subunit 421 is further configured to trigger the source LD ID maintenance subunit 423 when the LD ID allocated to the first LD by the first ISP conforms to the preset TE policy; and

the source LD ID maintenance subunit 423 is configured to maintain the source ID in the data packet unchanged.

The router can instruct a processor to select to forward a data packet to which ISP network, and forward the data packet to the second LD to which the second host belongs through the ISP network, so the router can implement management of the network traffic.

After being forwarded to the second LD to which the second host belongs, the data packet can be forwarded to the second host through the Locator in the second LD.

In the foregoing embodiment of the router, an independent IPv4 address space can be adopted inside each LD, the LD ID of each LD may be specifically a 96-bit unique global addressing, and may be considered as a /96 prefix of an IPv6 address, and the 96-bit LD ID+32-bit IPv4 address form a special IPv6 address.

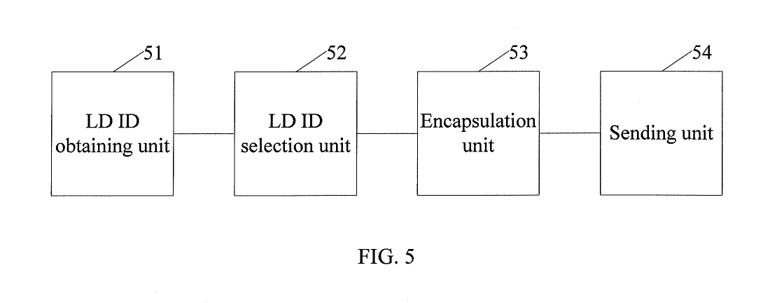

FIG. 5 is a schematic structural view of a host device according to an embodiment of the present disclosure, where the device includes:

an LD ID obtaining unit 51, configured to obtain LD IDs of a first LD belonging to ISPs, where the first LD belongs to a first ISP and a second ISP, and the ISPs to which the first LD belongs allocate the LD IDs to the first LD;

an LD ID selection unit 52, configured to select one from the obtained LD IDs;

an encapsulation unit 53, configured to take the LD ID selected by the LD ID selection unit 52 as a source LD ID and encapsulate the source LD ID in a data packet sent to a second host, where the second host belongs to a second LD; and

a sending unit 54, configured to send the data packet encapsulated by the encapsulation unit 53 to a first LDBR connected to an ISP network to which the first LD belongs.

The LD ID may be a 96-bit unique global addressing, which serves as a /96 prefix of an IPv6 address, the an independent IPv4 address space can be adopted inside the LD, and the 96-bit LD ID+32-bit IPv4 address form a special IPv6 address.

In view of the above, the host device can select to forward a data packet through which ISP network and select a path through which the data packet passes, so the network-level TE capability can be implemented.

The methods for sending data and forwarding data, the devices, and the multi-address space network according to the embodiments of the present disclosure are illustrated above in detail. The principles and implementation modes of the present disclosure have been illustrated through specific examples. The disclosed methods and devices may be implemented in software or hardware a combination of software and hardware. The hardware may include storage hardware such as hard disks which are accessible by processors. However, the description in the above embodiments is merely intended to make the methods and core ideas of the present disclosure comprehensible. It will be apparent to persons of ordinary skill in the art that various changes can be made to the implementation modes and application scopes of the present disclosure. In conclusion, the contents of the specification cannot be construed as limiting the present disclosure.

What is claimed is:

1. A method for forwarding data, comprising:
receiving a data packet sent by a first host to a second host, wherein a first host belongs to a first locator domain (LD), the first LD belongs to a first Internet service provider (ISP) and a second ISP, a second host belongs to a second LD, and the ISP to which each LD belongs allocates an LD identifier (ID) to the LD respectively; and
selecting one LD ID of the first LD as a source LD ID according to a preset traffic engineering (TE) policy, so as to obtain a second data packet corresponding to the first data packet, and selecting an ISP network corresponding to the source LD ID to forward the second data packet.

2. The method for forwarding data according to claim 1, wherein the data packet sent by the first host to the second host carries the source LD ID selected by the first host, the source LD ID is allocated by the first ISP to the first LD, and selecting one LD ID allocated to the first LD by the ISP to which the first LD belongs as the source LD ID according to the preset TE policy comprises:
modifying the source LD ID into the LD ID allocated to the first LD by the second ISP as the source LD ID when the LD ID allocated to the first LD by the first ISP does not conform to the preset TE policy.

3. The method for forwarding data according to claim 1, wherein the data packet sent by the first host to the second host carries the source LD ID selected by the first host, the source LD ID is allocated by the first ISP to the first LD, and the selecting one LD ID allocated to the first LD by the ISP to which the first LD belongs as the source LD ID according to the preset TE policy specifically comprises:
maintaining the source LD ID allocated by the first ISP to the first LD as the source LD ID when the source LD ID allocated to the first LD by the first ISP conforms to the preset TE policy.

4. The method for forwarding data according to claim 1, wherein the LD ID is a 96-bit unique global addressing allocated by the ISP, and an independent Internet Protocol version 4 (IPv4) address space is adopted inside the first LD and the second LD.

5. A method for sending data, comprising:
obtaining locator domain (LD) identifiers (IDs) of a first LD, wherein the first LD belongs to a first Internet service provider (ISP) and a second ISP, and selecting one LD ID as a source LD ID;
encapsulating the source LD ID in a data packet sent to a second host, wherein the second host belongs to a second LD; and
sending the data packet to an LD border router (LDBR) of the first LD, wherein the LDBR is connected to an ISP network that the LDBR belongs to.

6. The method for sending data according to claim 5, wherein the LD ID is a 96-bit unique global addressing, and an independent Internet Protocol version 4 (IPv4) address space is adopted in the LD.

7. A router, comprising:
a receiving unit, configured to receive a first data packet sent by a first host to a second host, wherein the first host belongs to a first locator domain (LD), the first LD belongs to a first Internet service provider (ISP) and a second ISP, the ISPs to which the first LD belongs allocate LD identifiers (IDs) to the first LD, and the second host belongs to a second LD;
a selection unit, configured to select one LD ID of the first LD as a source LD ID according to a preset traffic engineering (TE) policy, so as to obtain a second data packet corresponding to the first data packet; and
a sending unit, configured to send the second data packet obtained by the selection unit to an ISP network corresponding to the source LD ID selected by the selection unit.

8. The router according to claim 7, wherein the first data packet sent by the first host to the second host carries a source LD ID selected by the first host, the source LD ID is an LD ID allocated to the first LD by the first ISP, the selection unit comprises a policy determination subunit and a source LD ID modification subunit, wherein
the policy determination subunit is configured to determine whether the LD ID allocated to the first LD by the first ISP conforms to the preset TE policy, and trigger the source LD ID modification subunit when the LD ID does not conform to the preset TE policy; and
the source LD ID modification subunit is configured to modify the source LD ID into the LD ID allocated to the first LD by the second ISP.

9. The router according to claim 8, wherein the selection unit further comprises a source LD ID maintenance subunit, the policy determination subunit is further configured to trigger the source LD ID maintenance subunit when the LD ID allocated to the first LD by the first ISP conforms to the preset TE policy; and
the source LD ID maintenance subunit is configured to maintain the source ID in the data packet unchanged.

10. The router according to claim 7, wherein the LD ID is a 96-bit unique global addressing, and an independent Internet Protocol version 4 (IPv4) address space is adopted inside the first LD and the second LD.

11. A host device, comprising:
a locator domain identifier (LD ID) obtaining unit, configured to obtain LD IDs of a first LD belonging to Internet service providers (ISPs), wherein the first LD belongs to a first ISP and a second ISP, and the ISPs to which the first LD belongs allocate the LD IDs to the first LD;
an LD ID selection unit, configured to select one from the obtained LD IDs;
an encapsulation unit, configured to take the LD ID selected by the LD ID selection unit as a source LD ID and encapsulate the source LD ID in a data packet sent to a second host, wherein the second host belongs to a second LD; and
a sending unit, configured to send the data packet encapsulated by the encapsulation unit to a first LD border router (LDBR) connected to an ISP network to which the first LD belongs.

12. The host device according to claim 11, wherein the LD ID is a 96-bit unique global addressing, and an independent Internet Protocol version 4 (IPv4) address space is adopted inside the first LD and the second LD.

13. A multi-address space mobile network, comprising: a plurality of LDs adopting independent address spaces, wherein each LD has a unique LD identifier (LD ID) in the network; a first LD belongs to a first Internet service provider (ISP) and a second ISP, different LDs are connected to each other through LD border routers (LDBR)s;
a first host belongs to the first LD, a second host belongs to a second LD, and the ISPs to which the first LD and the second LD belong allocate the LD IDs to the first LD and the second LD respectively;
the first host, configured to send a first data packet to the second host; and
a first LDBR, configured to receive a data packet sent by the first host, select one LD ID of the first LD as a source LD ID according to a preset traffic engineering (TE) policy, so as to obtain a second data packet corresponding to the first data packet, and select an ISP network corresponding to the source LD ID to forward the second data packet.

14. The multi-address space mobile network according to claim 13, wherein the first data packet sent to the second host by the first host carries a source LD ID selected by the first host, the source LD ID is allocated to the first LD by the first ISP,
the first LDBR is specifically configured to determine whether the LD ID allocated to the first LD by the first ISP conforms to the preset TE policy, and modify the source LD ID into the LD ID allocated to the first LD by the second ISP as the source LD ID when the LD ID allocated to the first LD by the first ISP does not conform to the preset TE policy.

15. The multi-address space mobile network according to claim 14, wherein the first LDBR is further configured to maintain the source LD ID as the LD ID allocated to the first LD by the first ISP when the LD ID allocated to the first LD by the first ISP conforms to the TE policy.
